(19) United States
(12) Patent Application Publication
(10) Pub. No.: US 2010/0041446 A1
(43) Pub. Date: Feb. 18, 2010

(54) ELECTRONIC APPARATUS WITH POWER SAVING FUNCTION AND METHOD THEREOF

(75) Inventors: XIAO-GUANG LI, Shenzhen City (CN); KUAN-HONG HSIEH, Tu-Cheng (TW); SHIN-HONG CHUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/346,891

(22) Filed: Dec. 31, 2008

(30) Foreign Application Priority Data
Aug. 13, 2008 (CN) 200810303746.4

(51) Int. Cl. H04B 1/40; G06F 1/32

(52) U.S. Cl. 455/574; 713/321

(57) ABSTRACT

An electronic apparatus with a power saving function is provided. The electronic apparatus includes: one or more power managing subunits; a charge detecting module configured for detecting the remaining charge of the electronic apparatus; a charge range determining module configured for determining the charge range of the remaining charge of the electronic apparatus according to a power saving table; a managing module configured for determining whether the power managing subunit(s) should be in a statues of being enabled according to the power saving table and the determined charge range; and transmitting a control instruction to enable the power managing subunit(s) if the power managing subunit(s) should be enabled, and thus to keep the electronic apparatus in a power conserving state. A method for saving power of an electronic apparatus is provided.

### BACKGROUND

1. Technical Field

The disclosure relates to an electronic apparatus with power saving function and method thereof.

2. Description of Related Art

With the development of electronic technology, various battery-powered electronic apparatuses such as handsets, Personal digital assistants (PDAs), MP3 players, and e-books, have brought convenience to people. However, batteries used in the electronic apparatus may quickly run out of energy, and thus need to be charged or replaced frequently to replenish power. Otherwise, the electronic apparatuses will have no power to function.

Many solutions are brought out to reduce the power consumption of the electronic apparatuses, thus to prolong service times per charge of the batteries of the electronic apparatuses. Those solutions generally set a “standby state” or a “sleep state” for an electronic apparatus when it is not being actively used. In the “standby state” or the “sleep state”, the power supply to the electronic apparatus is reduced, thus reducing power consumption of the electronic apparatus.

However, in actual applications, even in the “standby state” or the “sleep state”, most components of the electronic apparatus are still in an enabled state and consume power, which results in that the electronic apparatus will not be able to function when needed due to quick loss of power.

Therefore, what is needed is an electronic apparatus and method which can further save power.

### BRIEF DESCRIPTION OF THE DRAWINGS

FIG. 1 is an exemplary hardware infrastructure block diagram of an electronic apparatus with power saving function in accordance with an exemplary embodiment.

FIG. 2 is a flowchart of a power saving method, according to an embodiment, implemented by the electronic apparatus of FIG. 1.

### DETAILED DESCRIPTION OF THE EMBODIMENTS

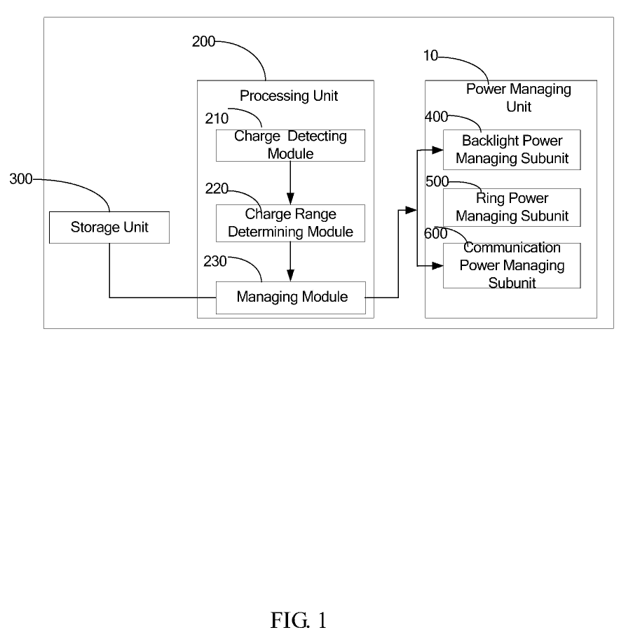

FIG. 1 is an exemplary hardware infrastructure block diagram of an electronic apparatus with power saving function in according with an exemplary embodiment. The electronic apparatus includes a storage unit 300, a processing unit 200, and at least one power managing unit 10. The power managing unit 10 is configured to control the power consuming function of the electronic apparatus by reducing power consumption by various functions according to a control instruction transmitted from the processing unit 200 correspondingly while keeping the electronic apparatus in a power conserving state. In the exemplary embodiment, the power managing unit 10 includes a backlight power managing subunit 400, a ring power managing subunit 500, and a communication power managing subunit 600.

The backlight power managing subunit 400 is configured to control power supply to a backlight (not shown), and able to adjust a brightness of the backlight and a duration of keeping the backlight on.

The ring power managing subunit 500 is configured to adjust ring mode of the electronic apparatus. For example, when the ring mode is in a vibration mode, the ring power managing subunit 500 adjusts a duration and a frequency of the vibration. Typically, the ring power managing subunit 500 reduces the duration and the frequency of the vibration. When the ring mode is in a ring tone mode, the ring power managing subunit 500 is able to randomly selects a polyphonic ring tone or a monophonic ring tone to replace a current ring tone which needs to be decoded before playing, e.g., a ring tone in MP3, WAV or WMA format and so on.

The communication power managing subunit 600 is configured to control a communication function of the electronic apparatus, for example, enabling or disabling the communication function.

The storage unit 300 is configured to store a power saving table. The power saving table records a plurality of charge ranges and operation statuses of power managing subunits, and a relationship between the charge ranges and statuses of the power managing subunits. For example, in the exemplary embodiment as shown below in TABLE 1, the power saving table shows the charge ranges, the power managing subunits, and a relationship between the charge ranges and the power managing subunits. In TABLE 1, “disable” means that the power managing subunit can't be enabled, “enable” means that the power managing subunit can be enabled, “q” means a charge which is a remaining charge in the charge range. For example, regarding the charge range “charge1≧q≧charge2,” none of power managing subunits can be enabled; regarding the charge “charge2>q≧charge3,” one kind of power managing subunit can be enabled, e.g., backlight power managing subunit; and so on.

TABLE 1

| | Power saving unit | | |
|---|---|---|---|
| | Backlight | | |
| | power | Ring power | Communication |
| | managing | managing | power managing |
| charge range | subunit | subunit | subunit |
| Charge1 ≧ q ≧ charge2 | disable | disable | disable |
| Charge2 > q ≧ charge3 | enable | disable | disable |
| Charge3 > q ≧ charge4 | enable | enable | disable |
| Charge4 > q ≧ charge5 | enable | enable | enable |

The processing unit 200 includes a charge detecting module 210, a charge range determining module 220, and a managing module 230.

The charge detecting module 210 is configured to detect a remaining charge. In the exemplary embodiment, the charge detecting module 210 detects a current passing through a battery of the electronic apparatus in a certain period of time to obtain the remaining charge.

The charge range determining module 220 is configured to determine the charge range of the remaining charge of the electronic apparatus.

The managing module 230 is configured to determine whether the power managing subunit(s) should be in a status of being enabled or disabled according to the power saving table and the determined charge range, and transmit a control instruction to enable the power managing subunit(s) upon the condition that the power managing subunit(s) should be enabled, thus to keep the electronic apparatus in a power conserving state. For example, in the exemplary embodiment, if the charge range determining module 220 determines that the remaining charge falls in the range of charge3>q>=charge4, the managing module 230 determines a backlight power managing subunit 400 and a ring power managing subunit 500 according to the power saving table and the determined charge range, transmits a control instruction to enable the determined power managing subunits, and to keep the electronic apparatus in a power conserving state.

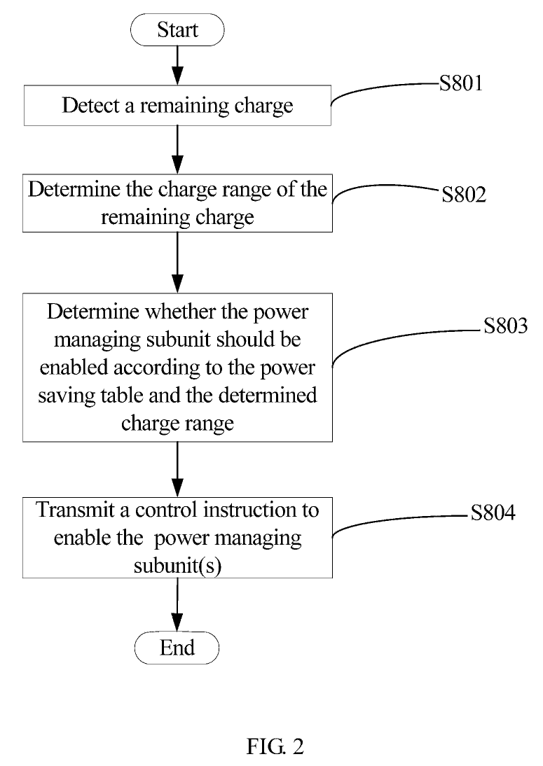

FIG. 2 is a flowchart of a power saving method, according to an embodiment, implemented by the electronic apparatus of FIG. 1.

In step S801, the charge detecting module 210 detects a remaining charge.

In step S802, the charge range determining module 220 determines the charge range of the remaining charge of the electronic apparatus.

In step S803, the managing module 230 determines whether the power saving subunit(s) should be enabled according to the power saving table and the charge range.

In step S804, the managing module 230 transmits a control instruction to enable the power managing subunit(s) upon the condition that the power managing subunit(s) should be enabled.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. An electronic apparatus with power saving function, comprising:
at least one power managing unit comprising one or more power managing subunits;
a storage unit storing a power saving table, wherein the power saving table records a plurality of charge ranges and a relationship between the charge ranges and statuses of the power managing subunits; and
a processing unit comprising:
a charge detecting module capable of detecting a remaining charge of the electronic apparatus;
a charge range determining module capable of determining the charge range of the remaining charge of the electronic apparatus;
a managing module capable of determining whether the power managing subunit(s) should be in a status of being enabled or disabled according to the power saving table and the determined charge range, and transmit a control instruction to enable the power managing subunit(s) upon the condition that the power managing subunit(s) should be enabled, thus to keep the electronic apparatus in a power conserving state.

2. The electronic apparatus as in claim 1, wherein the one or more power managing subunits comprise a backlight power managing subunit, the backlight power managing subunit is capable of controlling power supply to a backlight, and thus to adjust a brightness of the backlight and a duration of keeping the backlight on.

3. The electronic apparatus as in claim 1, wherein the one or more power managing subunits comprise a ring power managing subunit, the ring power managing subunit is capable of adjusting a ring mode of the electronic apparatus.

4. The electronic apparatus as in claim 3, wherein when the ring mode is in a vibration mode and the ring power managing subunit is enabled, the ring power managing subunit adjusts a duration and a frequency of the vibration.

5. The electronic apparatus as in claim 3, wherein when the ring mode is in a ring tone mode and the ring power managing subunit is enabled, the ring power managing subunit randomly selects a polyphonic ring tone or a monophonic ring tone to replace a current ring tone which needs to be decoded before play.

6. The electronic apparatus as in claim 1, wherein the one or more power managing subunits comprise a communication power managing subunit, the communication power managing subunit is capable of controlling a communication function of the electronic apparatus.

7. A power saving method applied on an electronic apparatus, wherein the electronic apparatus comprises one or more power managing subunits, the method comprising:
detecting a remaining charge of the electronic apparatus;
determining the charge range of the remaining charge of the electronic apparatus according to a power saving table, wherein the power saving table records a plurality of charge ranges and a relationship between the charge ranges and statues of the power managing subunits;
determining whether the power managing subunit(s) should be in a statues of being enabled according to the power saving table and the determined charge range; and
transmitting a control instruction to enable the power managing subunit(s) if the power managing subunit(s) should be enabled, and thus to keep the electronic apparatus in a power conserving state

8. The method as described in claim 7, wherein when the power managing unit to be enabled is a backlight power managing subunit, the step of transmitting a control instruction to enable the backlight power managing subunit(s) further comprises:
controlling the backlight managing unit to adjust power supply to a backlight, and thus to adjust a brightness of the backlight and a duration of keeping the backlight on.

9. The method as described in claim 7, wherein when the power managing unit to be enabled is a ring power managing subunit, the step of transmitting a control instruction to enable the ring power managing subunit(s) further comprises:
controlling the ring managing unit to adjust an ring mode of the electronic apparatus.

10. The method as described in claim 9, wherein the controlling step further comprises:
adjusting a duration and a frequency of a vibration in response to an incoming call, when the ring mode is in a vibration mode.

11. The method as described in claim 9, wherein the controlling step further comprises:
selecting a polyphonic ring tone or a monophonic ring tone to replace a current ring tone which needs to be decoded before play in response to an incoming call, when the ring mode is in a ring tone mode.

12. The method as described in claim 7, wherein when the power managing unit to be enabled is a communication power managing subunit, the step of transmitting a control instruction to enable the power managing subunit(s) further comprises:
controlling the communication managing unit to adjust a communication function of the electronic apparatus.
